(19) United States
(12) Patent Application Publication
(10) Pub. No.: US 2013/0314597 A1
(43) Pub. Date: Nov. 28, 2013

(54) PROJECTOR AND AUTHENTICATION METHOD

(71) Applicant: Osamu Kumamoto, Azumino-shi (JP)

(72) Inventor: Osamu Kumamoto, Azumino-shi (JP)

(73) Assignee: Seiko Epson Corporation, Tokyo (JP)

(21) Appl. No.: 13/983,978

(22) PCT Filed: Feb. 6, 2012
(86) PCT No.: PCT/JP2012/000774

§ 371 Date: Aug. 6, 2013

(30) Foreign Application Priority Data
Feb. 28, 2011 (JP) 2011-024615

(51) Int. Cl. H04N 5/44; H04N 5/445

(52) U.S. Cl. CPC H04N 5/44; H04N 5/445
USPC 348/552

(57) ABSTRACT

A projector includes a connection unit to which a portable terminal device is connected, a memory unit configured to store identification data of the portable terminal device to be permitted or denied, and a determination unit configured to determine whether to permit or deny use of the projector based on identification information of the portable terminal device received from the portable terminal device connected to the connection unit and the identification data.

### TECHNICAL FIELD

The present application claims priority from Japanese Patent Application No. 2011-024615 filed on Feb. 8, 2011, which is hereby incorporated by reference in its entirety.

This invention relates to a projector and an authentication method.

### BACKGROUND ART

For Example, as described in JP-A-2009-21743, a projector that performs authentication in response to a key operation using a remote control (remote controller) has been provided. Such a projector is available by input of a password or the like with a remote control or the like when activated.

### CITATION LIST

### Patent Literature

[PTL 1]

JP-A-2009-21743

### SUMMARY OF INVENTION

### Technical Problem

However, in the authentication system of inputting a password or the like, there are a problem that a proper user becomes unable to use because he or she has forgotten the password or the like, a problem of leakage of the password or the like, a problem of time and effort of changing the password or the like on a regular basis for improvement of the security level. Further, a biometric authentication system is provided as an authentication system for improving the security level while reducing time and effort of the user. However, in the case of the biometric authentication system, authentication is restricted with respect to each user. Particularly, in the case of a projector, authentication in units of groups using the projector may be necessary, and the projector may be used by an indefinite number of users. When the biometric authentication system is applied to the case, more time and effort are necessary. Further, an authentication system using a recording medium such as a USB memory, a PC card, or the like packed with the projector is also provided. However, only one recording medium corresponds to one projector, and thus, the authentication system is inappropriate for the case where security settings are configured with respect to plural users or each group.

### Solution to Problems

An advantage of some aspects of the invention is to provide a projector and an authentication method that can perform appropriate authentication while reducing time and effort of a user by solving the above described problems.

An aspect of the invention is directed to a projector including a connection unit to which a portable terminal device is connected, a memory unit configured to store identification data of the portable terminal device to be permitted or denied, and a determination unit configured to determine whether to permit or deny use of the projector based on identification information of the portable terminal device received from the portable terminal device connected to the connection unit and the identification data.

Another aspect of the invention is directed to an authentication method for a projector including a connection unit to which a portable terminal device is connected, and a memory unit configured to store identification data of the portable terminal device to be permitted or denied, the method including: receiving identification information of the portable terminal device from the portable terminal device connected to the connection unit, and determining whether to permit or deny use of the projector based on the identification information and the identification data.

According to the aspects of the invention, the projector determines whether to permit or deny use of the projector based on the identification information of the portable terminal device connected to the projector, and thereby, may perform appropriate authentication while reducing time and effort of the user.

Further, the projector may include an image generation unit configured to generate a determination result image indicating a determination result of permission or denial of the use by the determination unit, and a projection unit that projects the determination result image. According to the configuration, the projector may present the determination result of the permission or denial of the use to the user.

Furthermore, the projector may include an image supply device or a portable information storage medium connected to the projector, or an image signal input unit to which an image signal is input from the portable terminal device, wherein the image generation unit may generate an image based on the image signal and the projection unit may project the image if the determination result of the permission or denial of the use by the determination unit is permission. According to the configuration, the projector may appropriately determine permission or denial of the use of projection of the image.

In addition, the projector may include an updating unit, wherein the memory unit may store use time data representing total use time of the projector with respect to each portable terminal device, and the updating unit may update the use time data in response to a connection time of the portable terminal device to the connection unit. According to the configuration, the projector may acquire the total use time of the projector with respect to each portable terminal device, and may acquire the sum total use time by summing up the total use times of all portable terminal devices.

Further, the memory unit may store available time data representing available time of the projector with respect to each portable terminal device, and the determination unit may determine the permission or denial of use for the portable terminal device in connection to the connection unit as denial based on the use time data and the available time data if the total use time exceeds the available time, and determine the permission or denial of use for the portable terminal device in connection to the connection unit as permission if the total use time does not exceed the available time. According to the configuration, the projector may determine permission or denial of the use in response to the total use time with respect to each portable terminal device.

Furthermore, the projector may include an updating unit, wherein the memory unit may store use date and time data representing use date and time of the projector with respect to each portable terminal device, and the updating unit may update the use date and time data in response to connection date and time of the portable terminal device to the connection unit. According to the configuration, the projector may acquire the use date and time of the projector with respect to each portable terminal device, and may acquire information by summing up the use dates and times of all portable terminal devices.

In addition, the memory unit may store available date and time data representing available date and time of the projector with respect to each portable terminal device, and the determination unit may determine the permission or denial of use for the portable terminal device in connection to the connection unit as denial based on the use date and time data and the available date and time data if the use date and time do not match the available date and time, and determine the permission or denial of use for the portable terminal device in connection to the connection unit as permission if the use date and time match the available date and time. According to the configuration, the projector may determine the permission or denial of the use in response to the use date and time with respect to each portable terminal device.

### BRIEF DESCRIPTION OF DRAWINGS

[FIG. 1]

FIG. 1 shows a projection condition in the first embodiment.

[FIG. 2]

FIG. 2 is a functional block diagram of a projector in the first embodiment.

[FIG. 3]

FIG. 3 is a hardware block diagram of the projector in the first embodiment.

[FIG. 4]

FIG. 4 is a flowchart showing a processing procedure from authentication to projection in the first embodiment.

[FIG. 5]

FIG. 5 shows an example of an image based on an image signal in the first embodiment.

[FIG. 6]

FIG. 6 shows an example of a determination result image indicating denial in the first embodiment.

[FIG. 7]

FIG. 7 shows an example of a password protect image in the first embodiment.

[FIG. 8]

FIG. 8 shows an example of a management image in the first embodiment.

[FIG. 9]

FIG. 9 is a flowchart showing a processing procedure from authentication to projection in the second embodiment.

[FIG. 10]

FIG. 10 is a flowchart showing a processing procedure from authentication to projection in the third embodiment.

[FIG. 11]

FIG. 11 shows a projection condition in the fourth embodiment.

### DESCRIPTION OF EMBODIMENTS

Embodiments in which the invention is applied to projectors will be explained with reference to the drawings. Note that the following embodiments do not limit the invention described in the appended claims. Further, all of the configuration shown in the following embodiments may not be essential as solutions of the invention described in the appended claims.

### First Embodiment

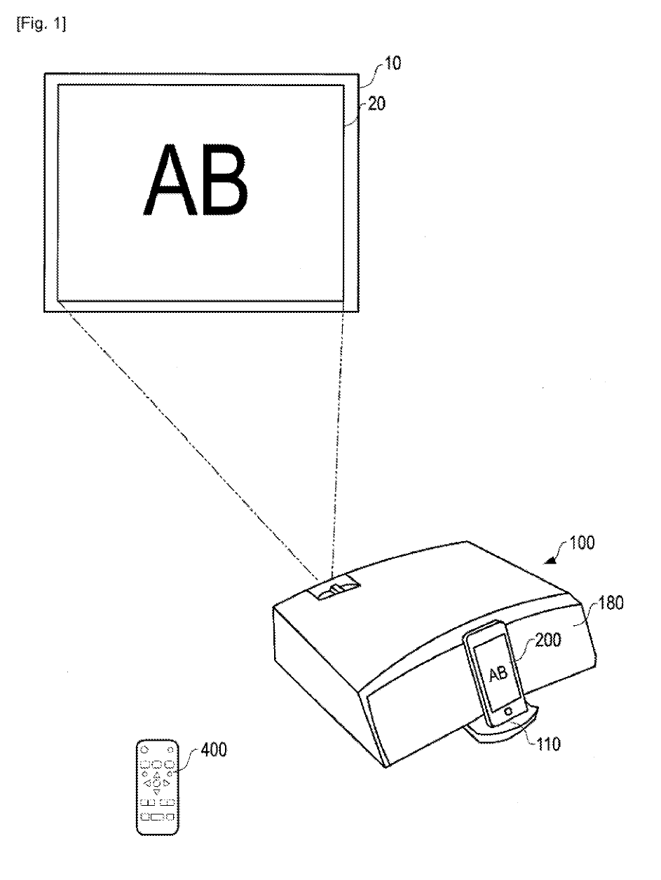

FIG. 1 shows a projection condition in the first embodiment. The projector 100 includes a connection unit 110 that can be retracted in the main body and can be protruded from the main body by sliding it with respect to the main body, an audio output unit 180, etc. A user operates a remote control 400 under the condition that the terminal part of a personal digital assistant 200 as a kind of portable terminal device is inserted into the connector provided in the connection unit 110, and thereby, allows the projector 100 to project an image based on an image signal from the personal digital assistant 200 and allows the projector 100 to output audio based on an audio signal from the personal digital assistant 200.

The projector 100 of the embodiment has a function of performing authentication based on identification information of the personal digital assistant 200, determining whether to permit or deny the use of the projector 100, and, only when permitting the use of the projector 100, performing projection of the image or output of audio under the condition that the personal digital assistant 200 is connected to the projector 100. Next, a functional block of the projector 100 having the function will be explained.

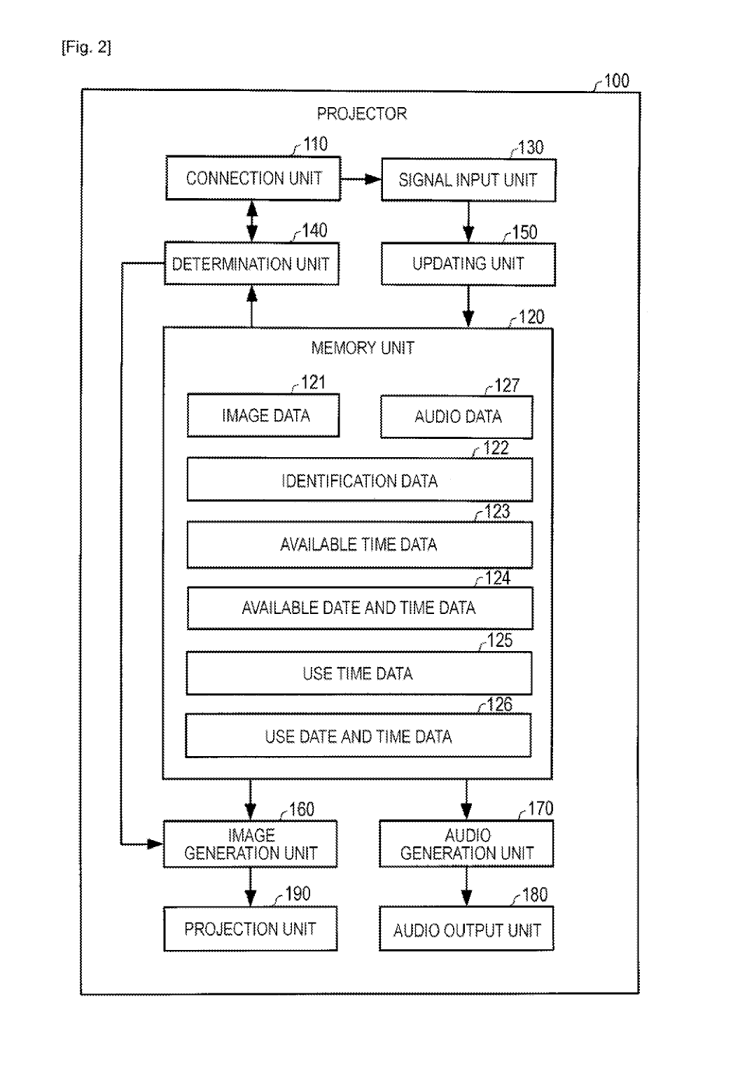

FIG. 2 is a functional block diagram of the projector 100 in the first embodiment. The projector 100 includes the connection unit 110 to which the personal digital assistant 200 is connected, a signal input unit 130 to which the image signal and the audio signal are input via the connection unit 110, a memory unit 120, an updating unit 150 that updates data within the memory unit 120, a determination unit 140 that determines whether to permit or deny the use of the projector 100 or the like, an image generation unit 160 that generates the image 20, a projection unit 190 that projects the image 20 on a screen 10 or the like, an audio generation unit 170, and the audio output unit 180.

Further, the memory unit 120 stores image data 121 as data for generation of a determination result image or the like and data representing an input image signal, audio data 127 as data representing an input audio signal, an identification data 122 representing the personal digital assistant 200 having permission of the use or the like, available time data 123 representing available time of the projector 100 with respect to each personal digital assistant 200, available date and time data 124 representing available date and time of the projector 100 with respect to each personal digital assistant 200, use time data 125 representing actual use time of the projector 100 with respect to each personal digital assistant 200, use date and time data 126 representing actual use date and time of the projector 100 with respect to each personal digital assistant 200, etc.

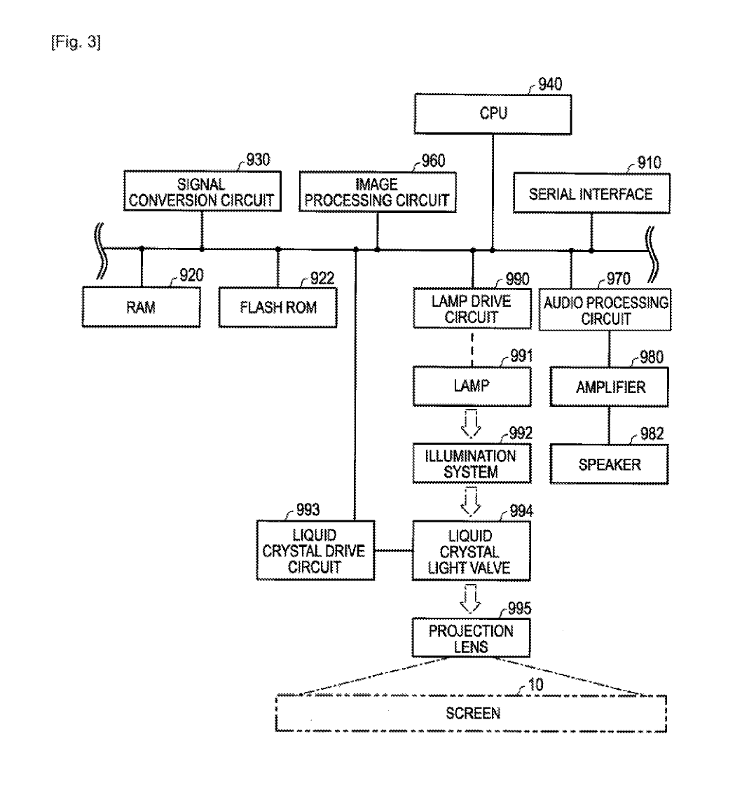

FIG. 3 is a hardware block diagram of the projector 100 in the first embodiment, and schematically shows the connection statuses of the respective units. For example, the connection unit 110 may be implemented using a serial interface 910 or the like, the memory unit 120 may be implemented using a RAM 920, a flash ROM 922, etc., the signal input unit 130 may be implemented using a signal conversion circuit 930 or the like, the determination unit 140 and the updating unit 150 may be implemented using a CPU 940 or the like, the image generation unit 160 may be implemented using an image processing circuit 960 or the like, the audio generation unit 170 may be implemented using an audio processing circuit 970 or the like, the audio output unit 180 may be implemented using an amplifier 980, a speaker 982, etc., the projection unit 190 may be implemented using a lamp drive circuit 990, a lamp 991, an illumination system 992, a liquid crystal drive circuit 993, a liquid crystal light valve 994, a projection lens 995, etc. Further, the signal input unit 130 may be implemented using an infrared communication unit or the like when receiving an infrared signal from the remote control 400.

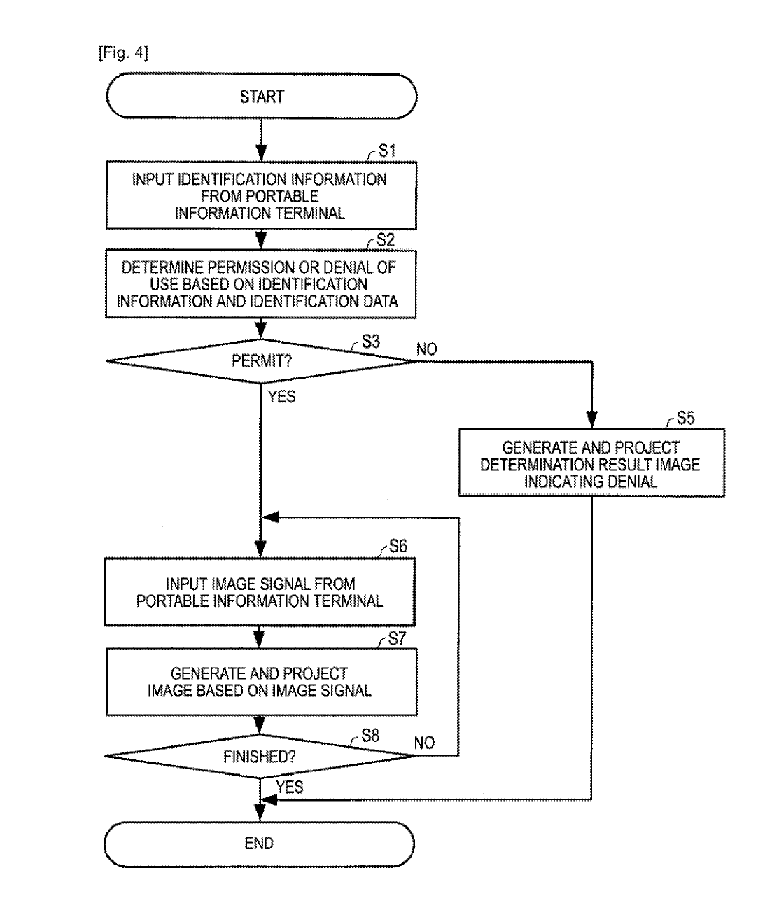

Next, a processing procedure from authentication to projection using these respective units will be explained. FIG. 4 is a flowchart showing a processing procedure from authentication to projection in the first embodiment. The user inserts the terminal part of the personal digital assistant 200 into the connector provided in the connection unit 110. Thereby, identification information of the personal digital assistant 200 from the personal digital assistant 200 is input to the connection unit 110 (step S1). Note that, in the embodiment, the identification information is a serial number unique to the personal digital assistant 200.

The determination unit 140 determines whether to permit or deny the use of the projector 100 based on the identification information of the personal digital assistant 200 from the connection unit 110 and the identification data 122 stored in the memory unit 120 (steps S2, S3). Specifically, for example, the determination unit 140 determines permission if the serial number of the personal digital assistant 200 is identical with the serial number indicating permission of the use contained in the identification data 122 and determines denial if not identical.

The image generation unit 160 generates a determination result image indicating denial if denial is determined by the determination unit 140, and the projection unit 190 projects the determination result image (step S5).

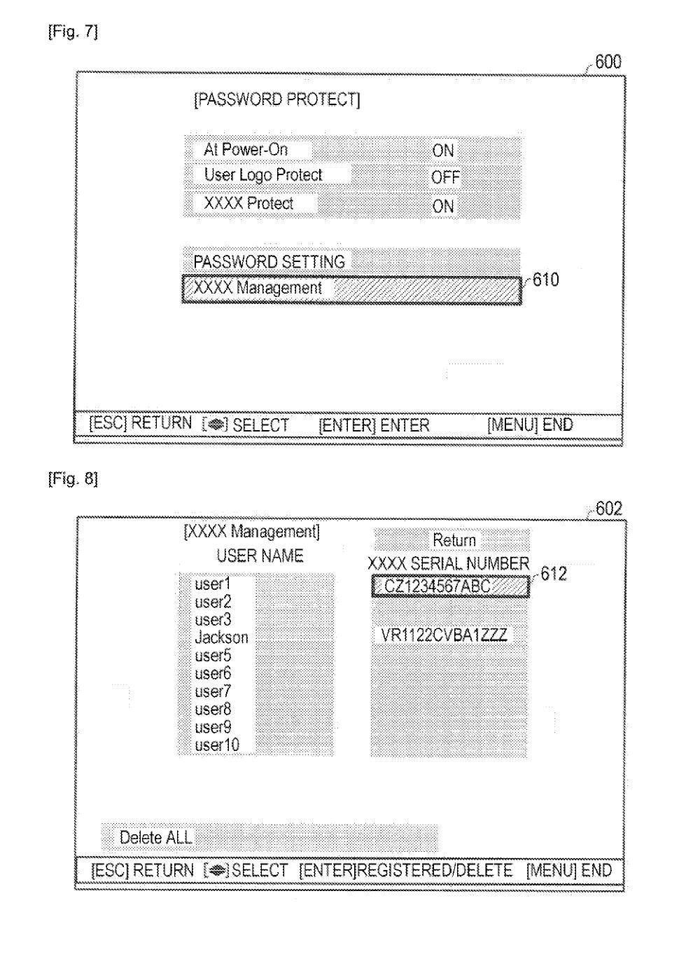

FIG. 6 shows an example of a determination result image 502 indicating denial in the first embodiment. For example, the determination result image 502 indicating denial is an image showing a character string such as “This XXXX is not registered”. The determination result image 502 is projected, and thereby, the user may know that the connected personal digital assistant 200 is inappropriate. Note that “XXXX” shows the product name of the personal digital assistant 200.

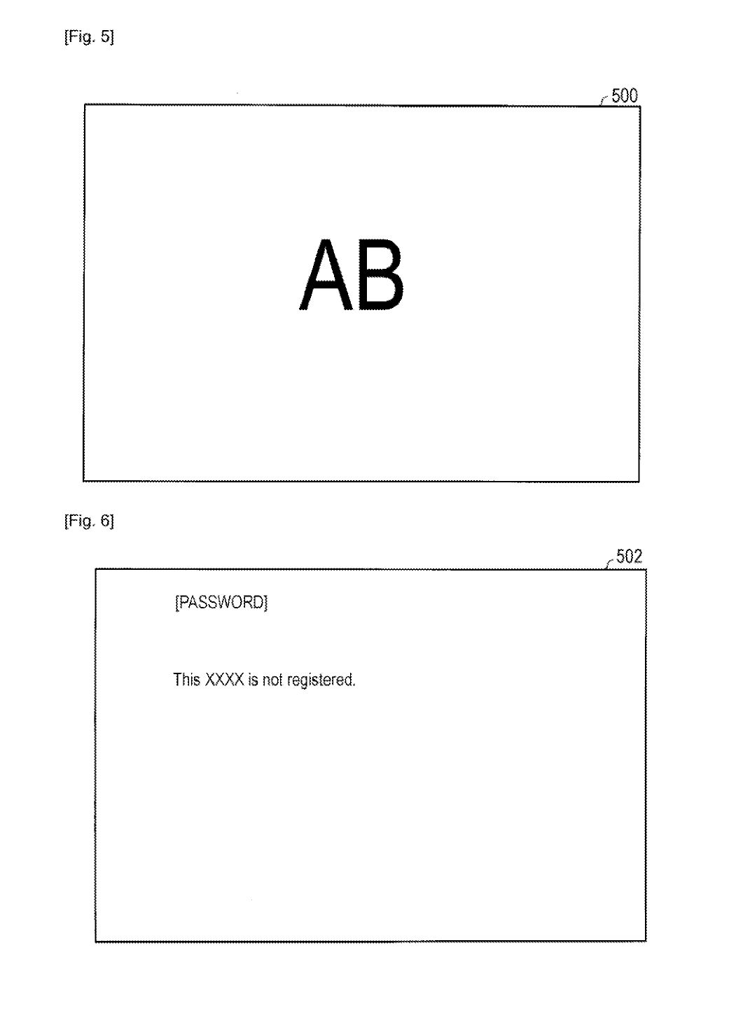

On the other hand, if permission is determined by the determination unit 140, the signal input unit 130 starts input of the image signal from the personal digital assistant 200 (step S6). Then, the image generation unit 160 generates an image 500 shown in FIG. 5 based on the image signal from the signal input unit 130, and the projection unit 190 projects the image 500 (step S7). FIG. 5 shows an example of the image 500 based on the image signal in the first embodiment, and shows that the image displayed on the personal digital assistant 200 is projected by the projection unit 190. The determination unit 140 determines whether or not there is an end instruction based on the operation information of the remote control 400 or the like (step S8), and the projector 100 continues image generation processing etc. if there is no end instruction (steps S6, S7) and ends the image generation processing etc. if there is an end instruction. In this manner, the image 500 is projected based on the image signal input from the personal digital assistant 200 without projection of the determination result image 502, and thereby, the user may know the connected personal digital assistant 200 is appropriate and the use of the projector 100 is permitted.

Here, a registration method of the serial number in the identification data 122 will be explained. FIG. 7 shows an example of a password protect image 600 in the first embodiment. Further, FIG. 8 shows an example of a management image 602 in the first embodiment. The determination unit 140 determines whether or not there is a projection instruction of the password protect image 600 based on the operation information of the remote control 400 or the like. If there is a projection instruction of the password protect image 600, the projector 100 projects the password protect image 600.

The password protect image 600 includes an image for selection of enabling or disabling password authentication at power-on of the projector 100 (for example, “At Power-On ON”), an image for selection of enabling or disabling device authentication by the personal digital assistant 200 in place of password authentication (for example, “XXXX Protect ON”), an image for change of the personal digital assistant 200 having permission of use or the like (for example, “XXXX management”), a cursor 610 indicating an object to be selected by the moving operation of the remote control 400, etc.

If “XXXX management” is selected, for example, the projector 100 projects the management image 602. The management image 602 includes an image showing the serial number of the personal digital assistant 200 having permission of use, an image showing a user name corresponding to the serial number, a cursor 612 for selection, “Delete ALL” for deleting all settings, etc. Note that the user name and the serial number are stored in the memory unit 120 as the identification data 122.

Here, up to ten personal digital assistants 200 can be registered, and the number of registerable devices is optional. Further, when the user name is selected by the cursor 612, if “Enter” button of the remote control 400 is pressed, the projector 100 projects an image showing the so-called software keyboard and updates the user name in response to the selection operation of characters within the image by the remote control 400. For example, the updating unit 150 updates the data representing the user name being selected within the identification data 122 in response to the selection operation.

Further, when the serial number is selected by the cursor 612, if the “Enter” button of the remote control 400 is pressed, the projector 100 projects an image for receiving selection as to whether or not the serial number and the user name corresponding to the serial number may be deleted. Note that the options indicated in the image may be “Yes”, “Only XXXX”, “No”, for example. If “Yes” is selected, for example, the updating unit 150 deletes the serial number selected in the identification data 122 and the user name corresponding to the serial number. Further, if “Only XXXX” is selected, for example, the updating unit 150 deletes only the serial number selected in the identification data 122, but does not delete the user name corresponding to the serial number. Furthermore, if “No” is selected, for example, deletion is not performed.

Further, when the management image 602 is displayed, if “Delete ALL” is selected, the projector 100 projects a delete-all confirmation image for receiving selection as to whether or not all of them may be deleted. If “Yes” is selected in the delete-all confirmation image, all of the serial number and the user name in the identification data 122 are deleted.

Furthermore, under the condition that the cursor 612 is located in a blank space of the serial number, if the “Enter” button of the remote control 400 is pressed, the projector 100 projects a registration confirmation image for selection as to whether or not the serial number of the personal digital assistant 200 connected to the connection unit 110 is registered. If “Yes” is selected in the registration confirmation image, the serial number is added to the identification data 122. Note that, in this case, for example, if “XXXX Protect” in the password protect image 600 is “Off”, use of the projector 100 is permitted by the authentication by password input, and thus, even when an unregistered personal digital assistant 200 is connected to the connection unit 110, the management image 602 may be projected.

As described above, according to the embodiment, the projector 100 determines whether to permit or deny the use of the projector 100 using identification information of the personal digital assistant 200 connected to the projector 100, and thereby, password input by the user is no longer necessary and appropriate authentication may be performed while time and effort of the user are reduced.

Further, according to the embodiment, the projector 100 may present the determination result as to whether to permit or deny the use to the user by projecting the image 500 based on the image signal and the determination result image 502. Thereby, the user may determine whether or not the personal digital assistant 200 that he or she has connected to the projector 100 is proper. Furthermore, according to the embodiment, the projector 100 may improve security by reproducing contents of the personal digital assistant 200 only when the use is permitted.

In addition, according to the embodiment, the projector 100 may register, change, delete the personal digital assistants 200 having permission of use using the password protect image 600, the management image 602, etc., and may register, change, delete the user names associated with the personal digital assistants 200.

### Second Embodiment

The projector 100 may improve security of the projector 100 by registering available time in the available time data 123, acquiring use time with respect to each personal digital assistant 200 in response to the connection status of the personal digital assistant 200, and denying the use of the projector 100 by the personal digital assistant 200 when the use time exceeds the available time.

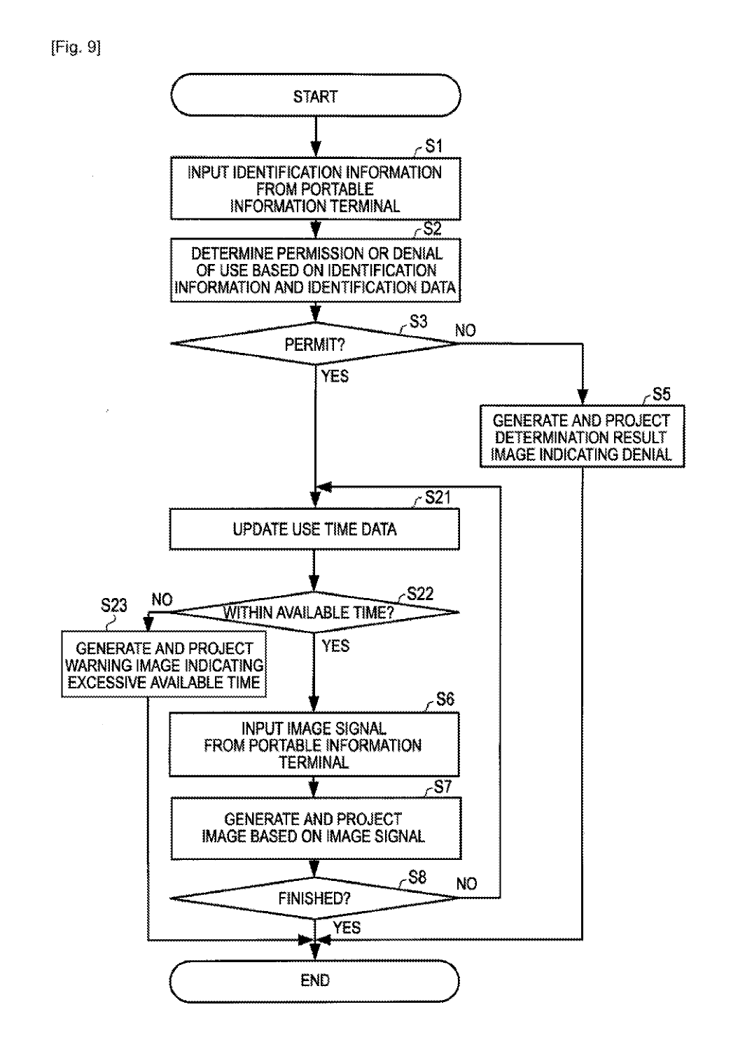

FIG. 9 is a flowchart showing a processing procedure from authentication to projection in the second embodiment. The explanation of the same processing as that of the first embodiment will be omitted. When the use of the projector 100 by the personal digital assistant 200 is permitted, the updating unit 150 updates the use time data 125 in response to the continuous connection time to the connection unit 110 of the personal digital assistant 200 (step S21).

The determination unit 140 determines whether or not the total use time of the personal digital assistant 200 in connection is within the available time based on the use time data 125 and the available time data 123 (step S22). Note that, if the total use time of the personal digital assistant 200 in connection exceeds the available time, the determination unit 140 determines permission or denial of use for the personal digital assistant 200 as denial, and if the total use time does not exceed the available time, determines permission or denial of use for the personal digital assistant 200 as permission.

If the total use time of the personal digital assistant 200 in connection exceeds the available time, the image generation unit 160 generates a warning image showing the excess of the available time, and the projection unit 190 projects the warning image (step S23). On the other hand, if the total use time does not exceed the available time, the projector 100 executes the processing at the above described steps S6 to S8, and projects the image 20.

As described above, according to the embodiment, the projector 100 may acquire the total use time of the projector 100 with respect to each personal digital assistant 200, and may acquire the sum total use time by summing up the total use times of all personal digital assistants 200. Thereby, for example, power saving settings in response to the usage status of the projector 100 or the like can be configured. Further, according to the embodiment, the projector 100 may determine permission or denial of use in response to the total use time with respect to each personal digital assistant 200. Note that the available time data 123 may be set to the same value (for example, 100 hours or the like) among all personal digital assistants 200, or set to different values (for example, 50 hours for the personal digital assistant 200 of user1, 300 hours for the personal digital assistant 200 of Jackson, etc.) with respect to each personal digital assistant 200.

### Third Embodiment

The projector 100 may improve security of the projector 100 by setting the available date and time (for example, specific year, month, day, an available period, an available time zone, an available day of the week, or the like) as the available date and time data 124 in common among all personal digital assistants 200, or setting them differently with respect to each personal digital assistant 200, acquiring use date and time of the personal digital assistant 200 in response to the connection status of the personal digital assistant 200, and denying the use of the projector 100 by the personal digital assistant 200 when the use date and time do not match the available date and time.

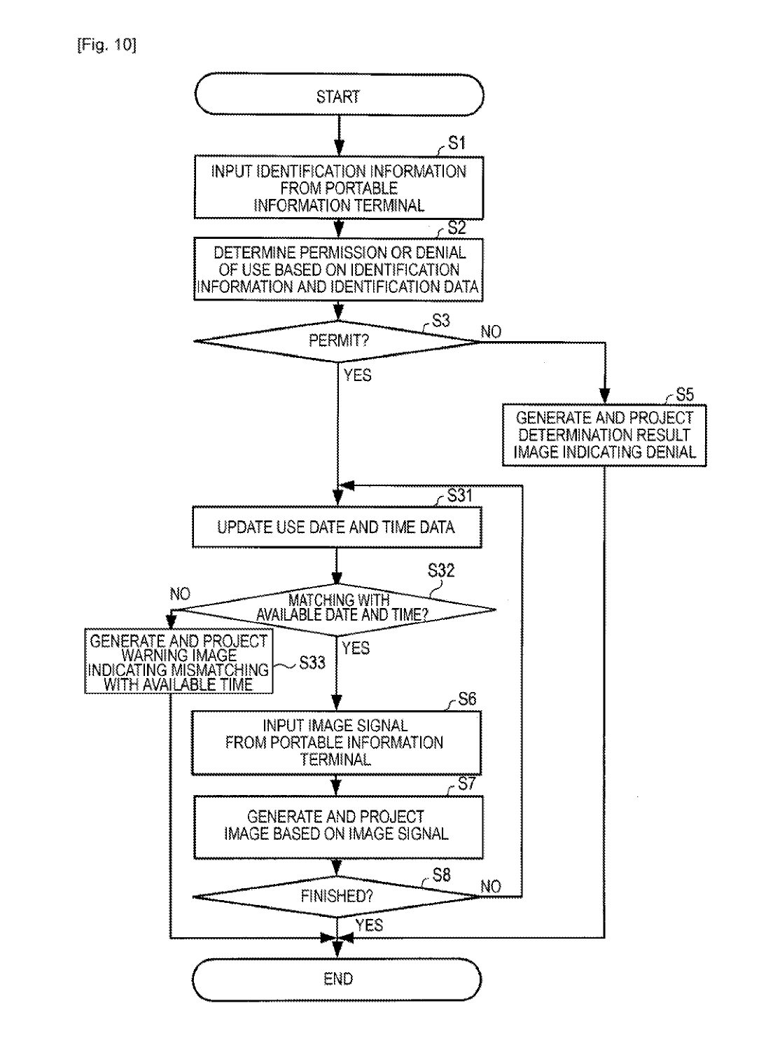

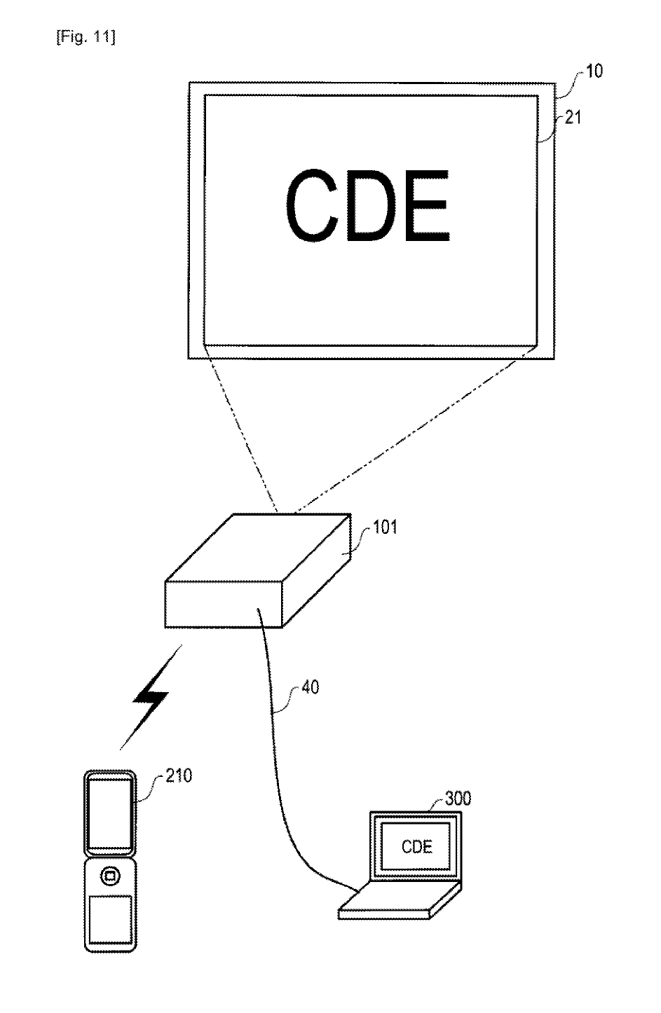

FIG. 10 is a flowchart showing a processing procedure from authentication to projection in the third embodiment. The explanation of the same processing as that of the first embodiment will be omitted. When the use of the projector 100 by the personal digital assistant 200 is permitted, the updating unit 150 updates the use date and time data 126 when the personal digital assistant 200 is connected to the connection unit 110 (step S31).

The determination unit 140 determines whether or not the actual use date and time of the personal digital assistant 200 in connection match the available date and time (for example, the use year, month, day match the available year, month, day, the use date and time are within the available period, the use time is within the available time zone, the use day of the week matches one of the available days of the week, or the like) based on the use date and time data 126 and the available date and time data 124 (step S32). Note that, if the use date and time of the personal digital assistant 200 in connection do not match the available date and time, the determination unit 140 determines permission or denial of use for the personal digital assistant 200 as denial, and if the use date and time of the personal digital assistant 200 in connection match the available date and time, determines permission or denial of use for the personal digital assistant 200 as permission.

If the use date and time of the personal digital assistant 200 in connection do not match the available date and time, the image generation unit 160 generates a warning image showing that the use date and time are inappropriate, and the projection unit 190 projects the warning image (step S33). On the other hand, if the use date and time of the personal digital assistant 200 in connection match the available date and time, the projector 100 executes the processing at the above described steps S6 to S8, and projects the image 20.

As described above, according to the embodiment, the projector 100 may acquire the use date and time of the projector 100 with respect to each personal digital assistant 200, and may acquire the information by summing up the use dates and times of all personal digital assistants 200. Thereby, for example, power saving settings in response to the usage status of the projector 100 or the like can be configured. Further, according to the embodiment, the projector 100 may improve security of the projector 100 because the projector may determine permission or denial of use in response to the use date and time with respect to each personal digital assistant 200.

### Fourth Embodiment

In the above described embodiments, the personal digital assistant 200 is directly connected to the connector of the projector 100, however, it may be connected via a USB cable or the like or wirelessly connected to the projector 100. Further, the portable terminal device is not limited to the personal digital assistant 200, but may be, for example, a notebook PC (Personal Computer), a cellular phone, a portable game machine, or the like. Furthermore, to the projector 100, image signals and audio signals may be input from an image supply device (for example, a PC, a DVD player, a game machine, or the like) other than the portable terminal device or a portable information storage medium (for example, a USB memory, a PC card, or the like), or the audio signals may be input from an audio supply device (for example, a portable music player, a CD player, an amplifier, or the like).

FIG. 11 shows a projection condition in the fourth embodiment. In the embodiment, a projector 101 is wirelessly connected to a cellular phone 210 as a kind of portable terminal device, and connected to a notebook PC 300 as a kind of image supply device via a display cable 40.

The projector 101 performs the above described determination of permission or denial of use for the cellular phone 210 in response to a request from the cellular phone 210. If the determination result is permission, the projector 101 projects an image 21 based on the image signal from the PC 300 and, if the determination result is denial, projects the determination result image 502 indicating denial and does not input the image signal from the PC 300.

As described above, according to the embodiment, the projector 101 exerts the same effects as those of the first embodiment.

### Other Embodiments

Note that the application of the invention is not limited to the above described embodiments, but may be modified and the configurations of the above described embodiments may be combined. For example, the second embodiment and the third embodiment may be combined. In this case, the determination unit 140 may perform determination by combining the available time and the available date and time. Further, the configurations of the projectors 100, 101 are not limited to the configuration shown in FIGS. 2 and 3. When the available time and the available date and time are not used, the available time data 123, the available date and time data 124, the use time data 125, and the use date and time data 126 are unnecessary. Further, when the projector has no audio output function, the audio data 127, the audio generation unit 170, and the audio output unit 180 are unnecessary.

In addition, the projectors 100, 101 may project an image including a character string such as “XXXX is being confirmed” when the personal digital assistant 200 or the like is connected to the connection unit 110, and then, project the determination result image 500 or the like. Further, the projector 100 may project an image showing a character string such as “successfully authenticated” as the determination result image and an image showing signs or graphics such as circles and crosses.

Furthermore, in the above described embodiments, if the determination result of the permission or denial of the use is denial, the projectors 100, 101 project the determination result image 502 indicating denial and end the processing, however, may project an image prompting password input after the projection of the determination result image 502 or as a part of the determination result image 502 and determine the permission or denial of the use again using the input password. According to the configuration, even when the personal digital assistant 200 unregistered in the projector 100 is connected to the projector 100, the user may use the projector 100 by performing password authentication.

In addition, the projectors 100, 101 may project an image including the user name set in the management image 602. According to the configuration, the name of the user or group corresponding to the personal digital assistant 200 in connection may be presented to the observer of the images 20, 21 or the like.

Further, the audio signal is input from the personal digital assistant 200 or the like to the projectors 100, 101 during projection of a standby image (for example, the so-called user logo image, the so-called screen saver, or the like), and the projectors may output audio based on the audio signal as BGM of the standby image.

In addition, the data registered in the identification data 122 is not limited to the identification information of the portable terminal device having permission of use, but may be identification information of the portable terminal device having denial of use. Further, the registration method is not limited to the above described method, but may be, for example, a method of collective registration using a definition file or the like. Furthermore, authority (an administrator authority, a general user authority, a guest authority, or the like) with respect to the portable terminal device may be added to the identification data 122. For example, the determination unit 140 may perform determination of permitting “Delete ALL” in the management image 602 only when the personal digital assistant 200 assigned with the administrator authority is connected.

Further, when operation buttons of play, stop, fast-forward, fast-rewind, etc. are provided on the remote control 400 and moving images and audio based on the signals from the personal digital assistant 200 or the like are reproduced, the projector 100 may reproduce the moving images and audio in response to instructions of play etc. from the remote control 400. Furthermore, the identification information and the identification data 122 are not limited to the serial numbers, but may be anything that may specify one portable terminal device from the same kind of portable terminal devices (for example, ID or the like). In addition, in the above described embodiments, the user name is also registered in the identification data 122, however, only the serial number may be registered in the identification data 122.

Further, the computers of the projectors 100, 101 may load the programs stored in the information storage medium and function as the determination unit 140 or the like. As the information storage medium, for example, a CD-ROM, a DVD-ROM, a ROM, a RAM, an HDD, or the like may be applied.

Further, the projectors 100, 101 are not limited to liquid crystal projectors (transmissive-type or reflective-type such as LCOS), but, for example, may be projectors using digital micromirror devices or the like. Furthermore, the projection unit 190 may employ a self-emitting device including a solid-state light source such as an organic EL device, a silicon light emitting device, a laser diode, or an LED in place of a lamp. In addition, the functions of the projectors 100, 101 may be distributed in plural devices (for example, a PC and a projector, or the like).

### REFERENCE SIGNS LIST

10 Screen
20, 21, 500 Image
40 Display Cable
100, 101 Projector
110 Connection unit
120 Memory unit
121 Image data
122 Identification data
123 Available time data
124 Available date and time data
125 Use time data
126 Use date and time data
127 Audio data
130 Image signal input unit
140 Determination unit
150 Updating unit
160 Image generation unit
170 Audio generation unit
180 Audio output unit
190 Projection unit
200 Portable information terminal (Portable information terminal device)
210 Cellular phone (Portable terminal device)
300 PC (Image supply device)
400 Remote
502 Determination result image
610, 612 Cursor
600 Password protect image
602 Management image
910 Serial interface
920 RAM
922 Flash ROM
930 Signal conversion circuit
940 CPU
960 Image processing circuit
970 Audio processing circuit
980 Amplifier
982 Speaker
990 Lamp drive circuit
991 Lamp
992 Illumination System
993 Liquid crystal drive circuit
994 Liquid crystal light valve
995 Projection lens

1. A projector comprising:
a connection unit to which a portable terminal device is connected;
a memory unit configured to store identification data of the portable terminal device to be permitted or denied; and
a determination unit configured to determine whether to permit or deny use of the projector based on identification information of the portable terminal device received from the portable terminal device connected to the connection unit and the identification data.

2. The projector according to claim 1, further comprising:
an image generation unit configured to generate a determination result image indicating a determination result of the permission or denial of the use by the determination unit; and
a projection unit that projects the determination result image.

3. The projector according to claim 2, further comprising an image supply device or a portable information storage medium connected to the projector, or an image signal input unit to which an image signal is input from the portable terminal device,
wherein the image generation unit generates an image based on the image signal if the determination result of the permission or denial of the use by the determination unit is permission, and
the projection unit projects the image.

4. The projector according to claim 3, wherein the image generation unit generates a determination result image if the determination result of the permission or denial of the use by the determination unit is denial, and the projection unit projects the determination result image.

5. The projector according to claim 1, further comprising an updating unit,
wherein the memory unit stores use time data representing total use time of the projector with respect to each portable terminal device, and
the updating unit updates the use time data in response to a connection time of the portable terminal device to the connection unit.

6. The projector according to claim 5, wherein the memory unit stores available time data representing available time of the projector with respect to each portable terminal device, and
the determination unit determines the permission or denial of use for the portable terminal device in connection to the connection unit as denial based on the use time data and the available time data if the total use time exceeds the available time, and determines the permission or denial of use for the portable terminal device in connection to the connection unit as permission if the total use time does not exceed the available time.

7. The projector according to claim 1, further comprising an updating unit,
wherein the memory unit stores use date and time data representing use date and time of the projector with respect to each portable terminal device, and
the updating unit updates the use date and time data in response to connection date and time of the portable terminal device to the connection unit.

8. The projector according to claim 7, wherein the memory unit stores available date and time data representing available date and time of the projector with respect to each portable terminal device, and
the determination unit determines the permission or denial of use for the portable terminal device in connection to the connection unit as denial based on the use date and time data and the available date and time data if the use date and time do not match the available date and time, and determines the permission or denial of use for the portable terminal device in connection to the connection unit as permission if the use date and time match the available date and time.

9. An authentication method by a projector including a connection unit to which a portable terminal device is connected, and a memory unit configured to store identification data of the portable terminal device to be permitted or denied, the method comprising:
receiving identification information of the portable terminal device from the portable terminal device connected to the connection unit, and
determining whether to permit or deny use of the projector based on the identification information and the identification data.
